(19) United States
(12) Patent Application Publication
(10) Pub. No.: US 2020/0293537 A1
(43) Pub. Date: Sep. 17, 2020

(54) System and Method for Lookalike Audience Extension from Sparse User Data

(71) Applicant: InMobi PTE LTD., Singapore (SG)

(72) Inventors: Sourabh Chaki, Bangalore (IN); Ameya Shrinivas Sakhalkar, Pune (IN); Vikas Singh, Pithoragrah (GB)

(73) Assignee: InMobi PTE LTD., Singapore (SG)

(21) Appl. No.: 16/356,761

(22) Filed: Mar. 18, 2019

(30) Foreign Application Priority Data
Mar. 13, 2019 (IN) 201841002307

(51) Int. Cl. G06F 16/2457; G06F 16/23; G06F 16/22

(52) U.S. Cl. CPC G06F 16/24578; G06F 16/2228; G06F 16/2379

(57) ABSTRACT

A system for populating a user features database for a plurality of unique user IDs is provided. The system includes a database for storing the plurality of unique user IDs, and a processor with a memory. The memory stores a plurality of modules to be executed by the processor, and wherein the plurality of modules are configured to assign a first score for a one or more features in the user features database, based on a historical data, for each of the plurality of unique user IDs, identify one or more neighborhood communities for each of the plurality of unique user IDs, calculate a second score for the one or more features in the user features database, for each of the plurality of unique user IDs in the one or more neighborhood communities, predict a third score for the one or more features in the user features database, based on a user to segment relationship, and compute feature weights for the one or more features using the first score, the second score and the third score for populating the user features database.

### FIELD OF TECHNOLOGY

The present disclosure generally relates to lookalike audience extension and more particularly to a system and a method for lookalike audience extension from sparse user data.

### BACKGROUND

Finding lookalike users or a lookalike audience is a common use case in content delivery services, for example in advertising domain. Typically, in advertising domain, lookalike users are used to build larger audiences from smaller segments to enhance reach for advertisers. The user segments are created by grouping users with similar interest, behavior or for some other commonality. Furthermore, in the context of marketing, lookalike users can be used to reach new prospects that look like a marketer's best customers. Using look-alike audience in on-line advertising campaigns helps an advertiser reach users similar to its existing customers. For conciseness, look-alike users are groups of people (audiences) who fit into the definition of an audience for a particular type of content. In at least one embodiment, lookalike audience refers to a new, expanded audience of entities, such as people, with one or more common or at least similar behaviors, demographics, interests, or other attributes to a “seed set” audience. Entities, such as people, who were directly “observed” taking a specific action, such as clicking an ad, filling out a form, or purchasing a. product are often referred to as a “seed. set” audience, which can be used to model the lookalike audience. Statistically, this lookalike audience is more likely than the average consumer to take a same desired action (such as click an advertisement or buy a product).

Lookalike audience extension is a practically effective way to customize high-performance audience in an on-line advertising. For example, the lookalike audience extension can mainly be used for prospecting, which involves finding new potential customers and/or visitors. However, it can also be used to extend the reach of online advertising campaigns. Marketing teams with growing sales targets are always looking to reach larger audiences.

Finding lookalike audience is a massive task and various approaches have been used in the prior art. In certain cases, unique identifiers associated with groups of users are arbitrarily assigned to a segment based on historical data. For example, a group of users sharing or liking a movie on a social networking site, may be construed as the group of users liking the genre to which the movie belongs. The group of users is then considered as an audience for delivering content associated with the particular movie genre. Similarly, ad networks that procure user related data from third party sources, generally receive user identifiers tagged to one or more ad segments arbitrarily. As such, while the audience size of the ad network increases, it may not result in increased click through rates and the like. Moreover, since user related data is often sparsely available, it may not be effective in extending the user database for various ad segments.

Yet another approach involves determining and quantifying features associated with the users over a period of time and using the quantified features to determine the segments to which the users would associate. However, this approach requires enormous amount of information related to the user set being analyzed for finding lookalikes and may not be suitable in cases, such as ad networks, where the user data is sparse.

### SUMMARY

In order to solve at least some of the above-mentioned problems, there exists a need for a system and a method for finding lookalike users for audience extension using sparse user data in a content delivery network.

This summary is provided to introduce a selection of concepts in simple manners that are further described in the detailed description of the disclosure. This summary is not intended to identify key or essential inventive concepts of the subject matter nor is it intended to determine the scope of the disclosure.

Briefly, according to an exemplary embodiment, a system for populating a user features database for a plurality of unique user IDs is provided. The system includes a database for storing the plurality of unique user IDs, and a processor with a memory. The memory stores a plurality of modules to be executed by the processor, and wherein the plurality of modules are configured to assign a first score for a one or more features in the user features database, based on a historical data, for each of the plurality of unique user IDs, identify one or more neighborhood communities for each of the plurality of unique user IDs, calculate a second score for the one or more features in the user features database, for each of the plurality of unique user IDs in the one or more neighborhood communities, predict a third score for the one or more features in the user features database, based on a user to segment relationship, and compute feature weights for the one or more features using the first score, the second score and the third score for populating the user features database. Further, computed feature weights are used to identify lookalike users for extending audience.

Briefly, according to an exemplary embodiment, a method for populating a user features database for a plurality of unique user IDs is provided. The method includes assigning a first score for a one or more features in the user features database, based on a historical data, for each of the plurality of unique user Ins in the user features database. The method further comprises identifying one or more neighborhood communities for each of the plurality of unique user IDs and calculating a second score for the one or more features in the user features database, for each of the plurality of unique user IDs in the one or more neighborhood communities. The method further includes predicting a third score for the one or more features in the user features database, based on a user to segment relationship. Furthermore, the method includes computing feature weights for the one or more features using the first score, the second score and the third score for populating the user features database and using the feature weights for the one or more features to identify lookalike users for audience extension.

The summary above is illustrative only and is not intended to be in any way limiting. Further aspects, exemplary embodiments, and features will become apparent by reference to the drawings and the following detailed description.

### BRIEF DESCRIPTION OF THE FIGURES

These and other features, aspects, and advantages of the exemplary embodiments can be better understood when the following detailed description is read with reference to the accompanying drawings in which like characters represent like parts throughout the drawings, wherein:

FIG. 1 is a block diagram of one embodiment of a system configured for populating a user features database for a plurality of unique user IDs for lookalike audience extension from sparse user data, according to an embodiment of the present disclosure;

FIG. 2 illustrates a user neighborhood graph for identifying one or more neighborhood communities for each of the plurality of unique user IDs for calculating a second score for the one or more features in the user features database, for each of the plurality of unique user IDs in the one or more neighborhood communities, according to an embodiment of the present disclosure;

FIG. 3 is a process flow diagram illustrating a method for populating a user features database for a plurality of unique user IDs for lookalike audience extension from sparse user data, according to an embodiment of the present disclosure; and

FIG. 4 is a block diagram of a computing device utilized for implementing the system of FIG. 1 according to an embodiment of the present disclosure.

Further, skilled artisans will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments described so as not to obscure the figures with details that will be readily apparent to those of ordinary skill in the art having the benefit of the description herein.

### DETAILED DESCRIPTION

For the purpose of promoting an understanding of the principles of embodiments of systems and methods described herein, reference will now be made to the embodiments illustrated in the figures and specific language will be used to describe the same without limiting the scope of the invention.

It will be understood by those skilled in the art that the foregoing general description and the following detailed description are exemplary and explanatory and are not intended to be restrictive.

The terms “comprises”, “comprising”, or any other variations thereof, are intended to cover a non-exclusive inclusion, such that a process or method that comprises a list of steps does not comprise only those steps but may comprise other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

The term ‘feature’ or ‘features’ as described herein refers to various attributes characterizing a user profile including but not limited to user age, location, demography, gender, interests, social behavior etc. One or more features associated with a user, when quantified, indicate the likelihood of the user towards a ‘segment’. While, the term segment has a general meaning, in the context of the present disclosure, ‘segment’ refers to various categories defined by the ad network or advertisers to correlate content associated with products or services with the users of the categories. For example, all users who have shown an interest towards one or more sport related content, would be considered as belonging to a sport segment.

The terms ‘user ID’, ‘user identifier’ and ‘user data’ are used interchangeably and refer to the unique identifier assigned to a user of a user device, in the user features database.

Unless otherwise defined, all technical and scientific terms used herein have the same meaning as commonly understood by one of ordinary skill in the art. The system, methods, and examples provided herein are illustrative only and not intended to be limiting.

In addition to the illustrative aspects, exemplary embodiments, and features described above, further aspects, exemplary embodiments of the present disclosure will become apparent by reference to the drawings and the following detailed description.

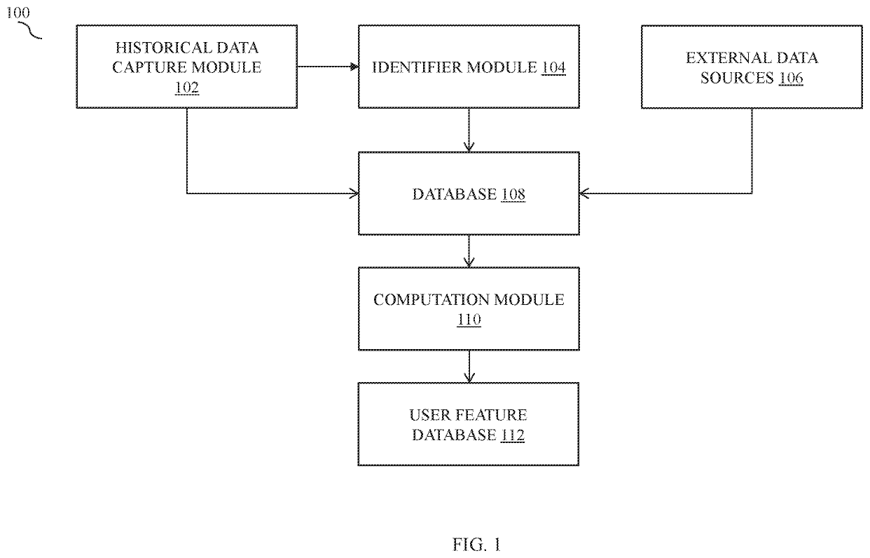

FIG. 1 is a block diagram of one embodiment of a system 100 configured for populating a. user features database for a plurality of unique user IDs for lookalike audience extension from sparse user data, according to an embodiment of the present disclosure. In particular, FIG. 1 illustrates a historical data capture module 102, an identifier module 104, one or more external data sources 106, a database 108, a computation module 110 and a user feature database 112. The system 100 configured for populating the user features database 112 for a plurality of unique user IDs includes the database 108 for storing the plurality of unique user IDs, and a processor with a memory, Wherein the memory stores a plurality of modules to be executed by the processor. The plurality of modules includes the historical data capture module 102 and the identifier module 104.

In one embodiment, the historical data capture module 102 is configured to record or capture the events such as clicks, downloads, purchases, share and other activities performed on the user devices associated with the one or more users. In one implementation, the historical data capture module 102 captures such events through browser cookies, APis, SDKs, etc. installed in the user device. Hence, the methods implemented by the historical data capture module 102 are similar to those used for click through rate (CTR) modelling, as is known in the art. In one example, the historical data comprises one or more of a user profile data, clicks, downloads, purchase history, browsing history or combinations thereof. Events such as clicks, downloads, purthase etc. are captured by the historical data capture module 102 every time the user of the user device performs one or more actions on the content (advertisements) rendered on the user device. Historical data for a pre-defined time period is captured and communicated to the processor for computing a first score for one or more features of the plurality of unique user IDs in the user features database 112.

In one embodiment of the present disclosure, the processor analyses the events/event data such as clicks, downloads, purchases, share and other activities captured by the historical data capture module 102 for determining user's direct features and hence to compute the first score for the one or more direct features. That is, the processor analyses the events reported by the one or more user devices associated with the one or more users, wherein the captured event data comprises details about the each of the said event. For example, a click event comprises details about actual and the category that the user has clicked, and similarly a download event comprises details about actual application being downloaded by the user. By analysing the event data, the processor assigns the first score for each of the one or more features as shown in Table 1. Hence, the first score indicates user's interest in different types of advertisements, contents, applications, lifestyles, etc.

| User ID | Feature f₁ | Feature f₂ |
|---|---|---|
| u₁ | 0 | 0 |
| u₂ | 0 | 1 |
| u₃ | 1 | 0 |
| u₄ | 1 | 0 |
| u₅ | 1 | 0 |
| u₆ | 0 | 0 |

In one embodiment of the present disclosure, the system is configured for deriving the one or more user's features from average neighborhood features. That is, the system creates one or more neighborhood communities by grouping the one or more user IDs that connects to a common network identifier. Additionally, the system is further configured for creating one or more neighborhood communities by grouping the one or more user IDs that reports a common geographical location. For example, the system captures users BSSID or IP address with consent from the users and creates the neighborhood community based on the common BSSID or IP address. The manner in which the system creates the one or more neighborhood community is explained in detail further below.

In one implementation, the identifier module 104 receives a location data of the plurality of user device (unique user IDs), wherein the location data is received by means of, for example, a MAC address, a BSS ID, an IP address, and geo-coordinate data. The location data at various instances in a pre-defined time period is received and stored by the identifier module 104. Further, the plurality of user IDs are grouped into one or more neighborhood communities, at least on the basis of the location data by the identifier module 104. In one embodiment, the one or more neighborhood communities are plotted on a time graph to identify common user IDs among the plurality of unique user IDs for visualizing on a user interface. The one or more neighborhood communities are, for example, points of interest, such as an office, home, shopping mall, airport, restaurant etc. The plurality of unique user IDs reporting similar location data at various instances over a period of time are grouped into a neighborhood community. Thus, it is possible for one unique user ID to be part of one or more neighborhood communities. In one embodiment, consent is taken from the users of the user device prior to receiving the location data.

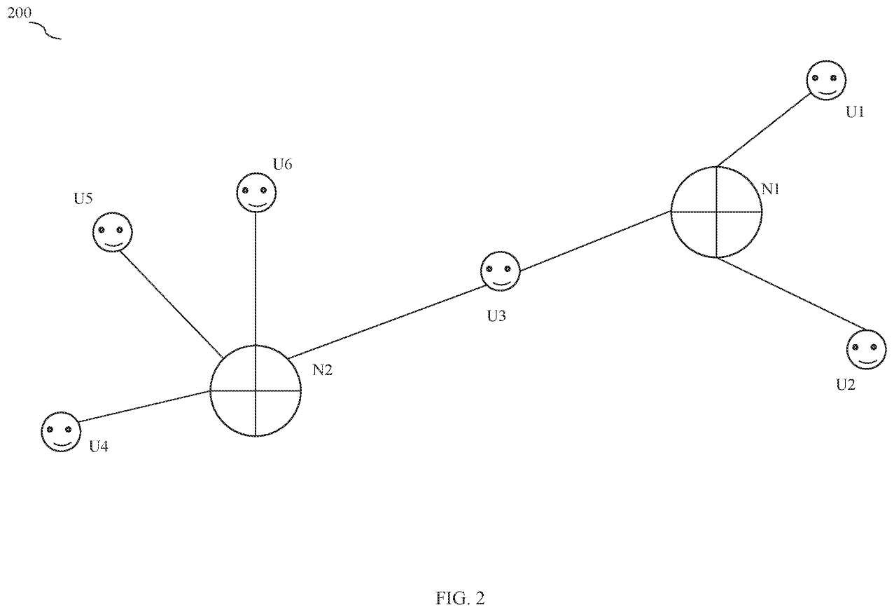

FIG. 2 illustrates an exemplary time graph 200 in accordance with an embodiment of the present disclosure. As described, the time graph is created based on the network identifiers reported by the one or more user devices over a period of time. For example, user devices associated with employees may report at least two network identifiers (home and office) over a period of 30 days and based on the network identifiers, the identifier module 104 creates one or more neighborhood communities. Referring to FIG. 2, users ‘u₁’, ‘u₂’ and ‘u₃’ belongs to a neighborhood community ‘n₁’, and the users ‘u₃’, ‘u₄’ ‘u₅’ and ‘u₆’ belongs to a neighborhood community ‘n₂’. That is, the user devices associated with the users ‘u1’, ‘u₂’ and ‘u₃’ reported a network identifier associated with ‘n₁’ frequently or over a period of time or for a pre-defined time period, wherein ‘n₁’ may be home Wi-Fi router. Further, the user devices associated with the users ‘u₃’, ‘u₄’ ‘u₅’ and ‘u₆’ reported a network identifier associated with ‘n₂’ frequently or over a period of time or for a pre-defined time period, wherein ‘n₂’ may be office network. As described, the user ‘u₃’ belongs to two communities ‘n₁’ and ‘n₁’. Similarly, the identifier module 104 creates plurality of neighborhood communities based on the network identifiers received from the user devices associated with the plurality of users.

Similarly, the geo-location data of the one or more user devices may be used to create the one or more neighborhood communities. In one implementation, the identifier module 104 is configured for capturing the geo location data of the user device when the system receives any http request from user device, wherein the geo-location data are captured as latitude and longitude co-ordinates. Alternatively, SDKs and APIs may be utilized to capture the geo-location data of the one or more user devices.

A set of several such proximal geolocations reported over a period of time are grouped to create points of interest. For example, ‘n’ number of unique user IDs may report geolocations varying in some degree but largely pointing to a shopping mall, or an airport or a residential complex and the like. The points of interest thus identified are used to create one or more neighborhood communities. It is thus possible for one user to be a part of one or more neighborhood communities. Creation of neighborhood communities provides additional information for inferring the likelihood of users to one or more user segments. The neighborhood score computed by the system 100 thus allows identifying potential users or user groups for one or more segments.

Further, the processor of the system 100 is configured to compute a second score for the one or more features for the plurality of unique user IDs in the one or more neighborhood communities identified by the identifier module 104. In one embodiment, the first score associated with one or more features for the plurality of unique user IDs in each neighborhood community is used to compute an average score for each of the one or more features for all the unique user IDs in each of the neighborhood communities. The average neighborhood feature score (nₐfᵢ) is computed using the equation:

nₐfᵢ−(sum of f₁ for all the user IDs in nₐ)/(total number of user IDs in n₀)

where nₐ represents the neighborhood community ‘a’ and fᵢ represents a feature ‘i’

Computation of the second score or the average neighborhood feature score is explained with reference to the Table 1 below:

TABLE 1

| User ID | Feature f₁ | Feature f₂ | Neighborhood | Nf₁ score | Nf₂ score |
|---|---|---|---|---|---|
| u₁ | 0 | 0 | nₐ | 0.33 | 0.33 |
| u₂ | 0 | 1 | nₐ | 0.33 | 0.33 |
| u₃ | 1 | 0 | nₐ, n_{b} | 1.08 | 0.33 |
| u₄ | 1 | 0 | n_{b} | 0.75 | 0 |
| u₅ | 1 | 0 | n_{b} | 0.75 | 0 |
| u₆ | 0 | 0 | n_{b} | 0.75 | 0 |

In the Table 1 above, u₁-u₆ represent six unique user IDs associated with six users and features f₁ and f₂ represent two exemplary features against which the first scores were assigned in the user features database 112, based on the historical data captured by the historical data capture module 102. In the neighborhood column, nₐ and n_{b} represent the two neighborhood communities for each of the six user IDs identified by the identifier module 104. Since, u₁, u₂ and u₃ belong to the neighborhood community nₐ, the average neighborhood score for the feature f₁ (Nf1score) will be 0.33 for all the users u₁, u₂ and u₃. That is, since u₁, u₂ and u₃ belong to the neighborhood community na, and u₁ has a first score 1 for feature f1, then the average neighborhood score for the feature f1 will be ((1+0+0)/3), which is 0.33, Similarly, the average neighborhood score for the feature f₂ for the user IDs u₄, u₅ to and u₆ will be zero since none of the user IDs in the neighborhood community n_{b} had a first score for the feature f₂.

In another embodiment, the processor of the system 100 computes a third score for each of the one or more features for all the unique IDs in the neighborhood community. Specifically, the third score is computed to determine the likelihood of a user in a neighborhood community to one or more segments. As described in earlier sections, segments are defined based on a threshold score of the one or more features for each unique user ID. For example, a user having user ID in belongs to segment s₁ if the feature score f₁ is more than 0.33. In another example, the user to segment relationship is directly obtained from one or more third party sources, that is, a user u₁ may be tagged to segment si without having any information about the feature scores f₁. The probability of users uᵢ belonging to a neighborhood nᵢ for a segment sᵢ is calculated as below:

psi for u₁=(number of users in sᵢ, in nᵢ)/(number of users in nᵢ)

Calculation of probability score for each user ID in the neighborhood community is explained with reference to Table 2 below:

TABLE 2

| User ID | Feature f₁ | Feature f₂ | Neighborhood | Segment | psᵢ |
|---|---|---|---|---|---|
| u₁ | 0 | 0 | nₐ | s₁ | 0.66 |
| u₂ | 0 | 1 | nₐ | s₃ | 0.66 |
| u₃ | 1 | 0 | nₐ, n_{b} | s₁, s₂, s₃ | 2.07 |
| u₄ | 1 | 0 | n_{b} | s₂ | 0.75 |
| u₅ | 1 | 0 | n_{b} | s₄ | 0 |
| u₆ | 0 | 0 | n_{b} | s₂ | 0.75 |

As can be seen from the Table 2 above, user IDs u₁, u₂ and u₃ belong to segment s₁ which correlates to u₁, u₂ and u₃ having one or more features with a score that meets the threshold of segment s₁. Similarly, user IDs u₃, u₄, u₅ and u₆ belong to segment s₂. The relationship between the one or more user IDs and the one or more segments may be derived from a third party source or from historical data. Since, two users from neighborhood nₐ-u₁ to and u₃ belong to segment s₁, the probability score for the user u₁ and u₂ to the segment s₁ is 0.66. Similarly, the probability score for all the user IDs in each neighborhood community is computed.

Further, the processor of the system 100 is configured for predicting a fourth score for the one or more features in the user features database for all the unique user IDs. In one embodiment, a machine learning algorithm is implemented by the processor of the system 100 to identify and score latent features for all the user IDs. The term ‘latent features’ is used herein since the features identified and scores predicted are generally not relatable to the user characteristics. In one example, a plurality of segment and segment definitions are provided as an input to the system 100 and a statistical model, such as a Latent Dirichlet allocation (LDA) model is generated to predict a. score for all the user IDs for each of the plurality of segments.

In one embodiment, the computation module 110 is configured for computing feature weights for the one or more features in the user features database 112, in order to obtain expand lookalike audience for a given segment. The aggregates of the first score—obtained based on historical data or the like, the second score, that is the neighborhood. feature score, the segment probability score (third score) and the fourth score, that is, the predicted score for latent features are quantified to obtain feature weights for the one or more features which are related to each of the one or more segments. The scores so obtained are collectively represented as derived user features, D. Hence,

D=(F, NF, SP, LF)

In the user features database 112, at least a number of unique user IDs known to be tagged to a segment sᵢ, are added to a sample or seed database and the remaining user IDs in the user feature database 112 having feature scores represented in D are then compared with the sample or seed database using one or more mathematical models to assign a feature weight wᵢ for each of the one or more features in the user features database corresponding to the segment sᵢ.

In one example, the importance of a feature i in the sample or seed database and the importance of the same feature i for all the remaining user IDs is computed as:

pᵢ(or qi)=(number of users with feature i)/(total number of users)

where, pᵢ and qᵢ represent the importance scores for the feature i in seed database and the database of remaining user IDs respectively,
The feature weight, wᵢ, is then computed as:

$$( {w}_{i} ) = \{ \begin{matrix}( {p}_{i} - {q}_{i} log ( ( ( {p}_{i} ( 1 - {q}_{i} ) ) \text{/} ( ( 1 - {p}_{i} ) {q}_{i} ) ) , if {p}_{i} - {q}_{i} > 0 \\ 0 , otherwise\end{matrix} \}$$

The feature weight wᵢ thus computed for every k^{th} segment is then multiplied with the feature scores D in order to identify lookalike users in the user features database for the segment k. The user score for the k^{th} segment is computed as:

USₖ=Σᵢ₌₀^{number of features}(dᵢ*wₖᵢ)

The user score US, thus computed for each unique user ID for each of the one or more segments is then used to populate user features database for each of the one or more segments. In one embodiment, the user features database 112 is updated periodically over a distributed computer network or the like. In another embodiment, the user features database 112 is updated for every new segment as and when new segments are defined in the system 100.

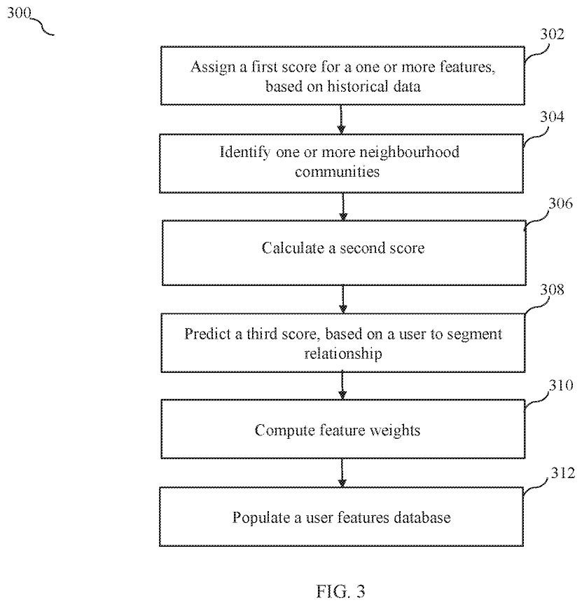

FIG. 3 is a flow chart illustrating a method 300 for populating a user features database for a plurality of unique user IDs for lookalike audience extension from sparse user data for online advertising, according to an embodiment of the present disclosure. FIG. 3 will be described from the perspective of a processor that is configured to execute computer-readable instructions to carry out the functionalities of the above described modules of system 100 shown in FIG. 1.

At step 302, a first score is assigned for a one or more features in the user features database, based on a historical data, for each of the plurality of unique user IDs. In one embodiment, the historical data capture module 102 of FIG. 1 is configured to record or capture the events such as clicks, downloads, purchases, share, activities tracked by browser cookies etc. by the one or more users on the user device (not shown). Methods implemented by the historical data capture module 102 are similar to those used for click through rate (CTR) modelling, as is known in the art. In one example, the historical data comprises one or more of a user profile data, clicks, downloads, purchase history, browsing history or combinations thereof. Events such as clicks, downloads, purchase etc. are captured by the historical data capture module 102 every time the user of the user device performs one or more actions on the content rendered on the user device. Historical data for a pre-defined time period is captured and communicated to the processor for computing the first scores for the plurality of unique user IDs in the user features database 112.

At step 304, one or more neighborhood communities are identified for each of the plurality of unique user IDs. In one embodiment, the identifier module 104 of FIG. 1 is configured for identifying one or more neighborhood communities for each of the plurality of unique user IDs in the user features database 112. In one embodiment, the identifier module 104 receives a location data of the plurality of unique user IDs from the user devices to which each of the plurality of unique user IDs is associated. The location data is, for example, an SS ID, MAC address, a BSS ID, an IP address, and geo-coordinate data. The location data at various instances in a pre-defined time period is received and stored by the identifier module 104. Further, the plurality of user IDs are grouped into one or more neighborhood communities, at least on the basis of the location data by the identifier module 104. In one embodiment, the one or more neighborhood communities are plotted on a time graph to identify common user IDs among the plurality of unique user IDs for visualizing on a user interface. The one or more neighborhood communities are, for example, points of interest, such as an office, home, shopping mall, airport, restaurant etc. The plurality of unique user IDs reporting similar location data at various instances over a period of time are grouped into a neighborhood community. Thus, it is possible for one unique user ID to be part of one or more neighborhood communities. In one embodiment, consent is taken from the users of the user device prior to receiving the location data.

At step 306, a second score is calculated for the one or more features in the user features database, for each of the plurality of unique user IDs in the one or more neighborhood communities. In one embodiment, the processor of the system 100 is configured to compute a second score for the one or more features for the plurality of unique user IDs in the one or more neighborhood communities identified by the identifier module 104. In one embodiment, the first score associated with one or more features for the plurality of unique user IDs in each neighborhood community is used to compute an average score for each of the one or more features for all the unique user IDs in each of the neighborhood communities. The average neighborhood feature score (nₐfᵢ) is computed using the equation:

nₐfᵢ−(sum of fᵢ for all the user IDs in nₐ)/total number of user IDSs in nₐ)

where nₐ represents the neighborhood community ‘a’ and fᵢ represents a feature ‘i’.

At step 308, a third score for each feature of a user ID in a neighborhood is computed based on the information pertaining to relationship between the one or more user IDs in the neighborhood to a segment. For example, if two user IDs u₁ and u₂ belonging to a neighborhood community n₁ comprising four users u₁, u₂, u₃ and u₄ are known to be associated with segment s₁, then a likelihood score for all the users belonging to n₁ is computed and assigned to all the user IDs of the neighborhood n₁.

Further, at step 310, a fourth score is predicted for the one or more features in the user features database, based on a user to segment relationship. In one embodiment, the processor of the system of the system 100 is configured for predicting the fourth score for the one or more features in the user features database for all the unique user IDs. In one embodiment, a machine learning algorithm is implemented by the processor of the system 100 to identify and score latent features for all the user IDs. The term ‘latent features’ is used herein since the features identified and scores predicted are generally not relatable to the user characteristics. In one example, a plurality of segment and segment definitions are provided as an input to the system 100 and a statistical model, such as a Latent Dirichlet allocation (LDA) model is generated to predict a score for all the user IDs for each of the plurality of segments.

At step 310, feature weights are computed for the one or more features using the first score, the second score and the third score for populating the user features database. In one embodiment, the computation module 110 of FIG. 1 is configured for computing feature weights for the one or more features in the user features database 112, in order to obtain lookalike audience for a given segment. The aggregates of the first score—obtained based on historical data or the like, the second score, that is the neighborhood feature score, the third score, that is the segment probability score for the neighborhood and the fourth score, that is, the predicted score for latent features is quantified to obtain feature weights for the one or more features which are related to each of the one or more segments. The scores so obtained are collectively represented as derived user features, D.

D=(F, NF, SP, LF)

At step 312, a user features database is populated for a plurality of unique user IDs. In the user features database 112 as shown in FIG. 1, at least a number of unique user IDs are known to be tagged to a segment sᵢ, are added to a sample or seed database and the remaining user IDs in the user feature database 112 having feature scores represented in D are then compared with the sample or seed database using mathematical models to assign a feature weight wᵢ for each of the one or more features in the user features database corresponding to the segment sᵢ.

In one example, the importance of a feature i in the sample or seed database and the importance of the same feature i for all the remaining user IDs is computed as:

pᵢ(or qᵢ)=(number of users with feature i)/(total number of users

where, pᵢ and qᵢ represent the importance scores for the feature i in seed database and the database of remaining user IDs respectively.
The feature weight, wᵢ, is then computed as:

$$( {w}_{i} ) = \{ \begin{matrix}( {p}_{i} - {q}_{i} log ( ( ( {p}_{i} ( 1 - {q}_{i} ) ) \text{/} ( ( 1 - {p}_{i} ) {q}_{i} ) ) , if {p}_{i} - {q}_{i} > 0 \\ 0 , otherwise\end{matrix} \}$$

The feature weight wᵢ thus computed for every k^{th} segment is then multiplied with the feature scores D in order to identify lookalike users in the user features database for the segment k as follows:

USₖ=Σᵢ₌₀^{number of features}(dᵢ*wₖᵢ)

where USₖ represents the score of a given user ID for a segment ‘k’ among the plurality of segments. The score thus computed is used to evaluate each of the one or more user IDs to expand the user features database for the plurality of segments. In at least one embodiment, the feature weights of the one or more features for each of the plurality of unique user IDs is determined using a relevancy score calculated as:

$$relevancy score = \frac{number of users with feature i}{total number of users}$$

for each of the plurality of segments.

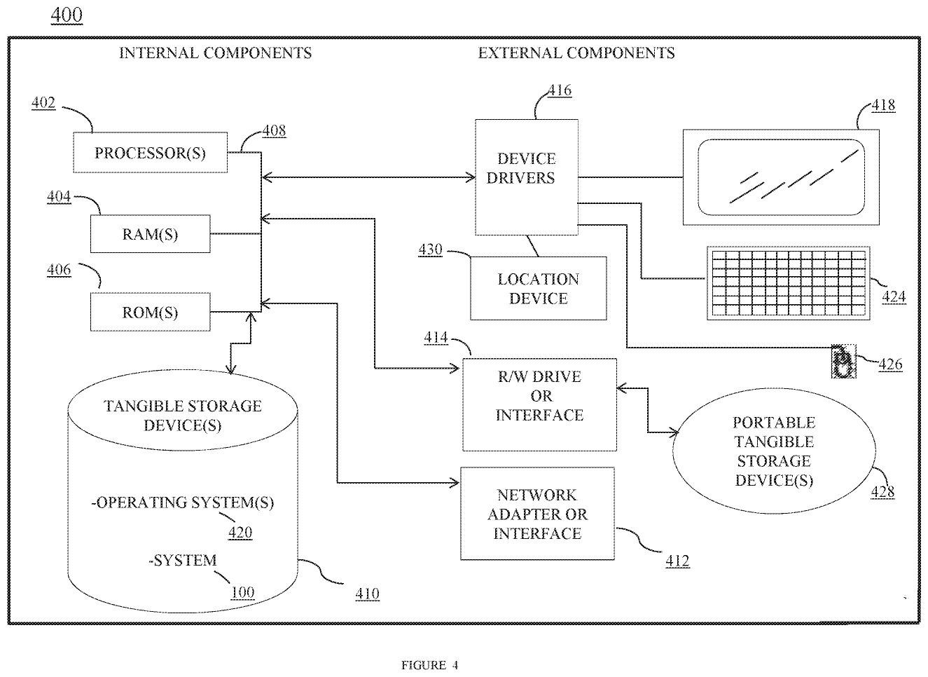

FIG. 4 is a block diagram of a computing device 400 utilized for implementing the system 100, according to an embodiment of the present disclosure. The components of the system 100 described herein are implemented in computing devices. One example of a computing device 400 is described below in FIG. 4. The computing device comprises one or more processor 402, one or more computer-readable RAMS 404 and one or more computer-readable ROMs 406 on one or more buses 408. Further, computing device 400 includes a tangible storage device 410 that may be used to execute operating systems 420 and modules existing in controller 108 of system 100. The various components of the system 100 including a personalization module, an identifier module 104, an external data sources 106, a database 108, a computation module 110 can be stored in tangible storage device 410. Both, the operating system and the modules existing in controller 108 of system 100 are executed by processor 402 via one or more respective RAMs 404 (which typically include cache memory).

Examples of storage devices 410 include semiconductor storage devices such as ROM 406, EPROM, flash memory or any other computer-readable tangible storage device 410 that can store a computer program and digital information. Computing device also includes R/W drive or interface 414 to read from and write to one or more portable computer-readable tangible storage devices 428 such as a CD-ROM, DVD, memory stick or semiconductor storage device. Further, network adapters or interfaces 412 such as a TCP/IP adapter cards, wireless wi-fi interface cards, or 3G or 4G wireless interface cards or other wired or wireless communication links are also included in computing device 400. In one embodiment, the modules existing in the processor of system 100 can be downloaded from an external computer via a network (for example, the Internet, a local area network or other, wide area network) and network adapter or interface 412. Computing device 400 further includes device drivers 416 to interface with input and output devices. The input and output devices can include a computer display monitor 418, a keyboard 424, a keypad, a touch screen, a computer mouse 426, and/or some other suitable input device.

While specific language has been used to describe the disclosure, any limitations arising on account of the same are not intended. As would be apparent to a person skilled in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. A system for populating a user features database for a plurality of segments, the system comprising:
a database for storing a plurality of unique user IDs and one or more features associated with each of the plurality of unique user IDs;
a processor coupled with a memory, wherein the memory stores a plurality of modules to be executed by the processor, and wherein the plurality of modules are configured to:
compute a plurality of scores for the one or more features; determine the feature weights for the one or more features using the plurality of scores;
compare the feature weights for the one or more features of each of the plurality of unique user IDs with each of the plurality of segments;
add the one or more unique user IDs to the user features database for each of the plurality of segments.

2. A method for populating a user features database for a plurality of segments, the method comprising:
computing a plurality of scores for the one or more features for each of the plurality of unique user IDs stored in a database;
determining the feature weights of the one or more features for each of the plurality of segments;
comparing a product of feature weights and the plurality of scores for the one or more features with each of the plurality of segments;
adding the one or more unique user IDs from the plurality of unique user IDs to the user features database for each of the plurality of segments based on the comparison.

3. The method as claimed in claim 2, wherein the plurality of scores comprises a first score based on a historical activity data associated with each of the plurality of unique user IDs.

4. The method as claimed in claim 2, wherein the plurality of scores comprises a second score based on a neighborhood of each of the plurality of unique user IDs.

5. The method as claimed in claim 4, wherein the neighborhood is identified using location data received from a user device associated with each of the plurality of unique user IDs and grouping the location data from the user device associated with each of the plurality of unique user IDs over a pre-defined time period.

6. The method as claimed in claim 5, wherein the location data comprises one of a MAC address, a BSS ID, an IP address, and geo-coordinate data.

7. The method as claimed in claim 2, wherein the plurality of scores comprises a third score calculated using a user to segment relationship in a neighborhood.

8. The method as claimed in claim 2, wherein the plurality of scores comprises a fourth score predicted using a third party user to segment relationship information.

9. The method as claimed in claim 2, wherein the feature weights of the one or more features for each of the plurality of unique user IDs is determined using a relevancy score calculated as:
$$relevancy score = \frac{number of users with feature i}{total number of users}$$
for each of the plurality of segments.
